(19) United States
(12) Patent Application Publication
(10) Pub. No.: US 2011/0296735 A1
(43) Pub. Date: Dec. 8, 2011

(54) System and methods to avoid insect attacks

(75) Inventors: Wolfgang Richter, Starnberg (DE); Faranak Zadeh, Vancouver (CA)

(73) Assignee: R2Z Innovations, Inc., Vancouver (CA)

(21) Appl. No.: 13/151,508

(22) Filed: Jun. 2, 2011

Related U.S. Application Data
(60) Provisional application No. 61/350,933, filed on Jun. 3, 2010.

(51) Int. Cl. A01M 29/24

(52) U.S. Cl. 43/1

(57) ABSTRACT

The invention teaches at least one system and/or methods to protect humans and/or animals or plants (as targets) from bloodsucking or parasitic purposes by a variety of insects. Mosquitoes spread malaria that annually affects two hundred million people and results in two million deaths every year. This innovation will show a new and environmentally defensive approach against such attacks by using generated alternating electric fields, which create a kind of synthetic aura around a subject like an invisible shield. Combined means of frequencies, voltage levels or modulations influence the nervous system of attacking organisms to avoid or ignore the target or force them to escape.

### PRIORITY

This application claims priority to U.S. Provisional Application No. 61/350,933 filed on Jun. 3, 2010, the entire contents of which are incorporated herein by references.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### INTRODUCTION

The invention teaches at least one system and/or methods to protect humans and/or animals (as targets) from bloodsucking or parasitic purposes by a variety of insects. Mosquitoes spread malaria that annually affects two hundred million people and results in two million deaths every year. Diseases like arboviruses, plague, enteric diseases, Lyme disease, sleeping sickness, American Trypanosomiasis and others come from the bite or stitch of an insect. Millions of people suffer from itching and scratching as well as possible infections caused by insect attacks. This innovation will show a new and environmentally defensive approach against such attacks by using generated alternating electric fields.

### THE INNOVATION UNDERLYING PROBLEMS

Insects, especially mosquitoes, can sense a human from a distance away by detecting a molecular combination of evaporation from human (animal) skin (dermis). Although it is well known how they find their host, it is still a challenge to prevent insect attacks. Typical commercial products deliver chemicals to prevent stitches and bites by confusing the insects' sensitive sensing system with an overwhelming smell. Therefore, there are a variety of sprays, oils and creams on the market. They all have to be applied either directly on the skin, or sprayed in the environment. Overall, however, they are uncomfortable to use, and some of the chemicals are irritants when they get into eyes or harmful for children and smaller animals. The innovation described in this application illustrates a new approach with a defense system against mosquitoes or other insects or sensing animals without the use of chemicals or expensive methods.

### SOLUTION ACCORDING TO THE INVENTION

As any nervous system functions on an electrochemical basis, it is possible to introduce signals into such a system either with chemicals or electrical signals. Such signals cause activities in an insect (e.g. mosquitoes) brain, for example to not attack or to stay away from a possible danger.

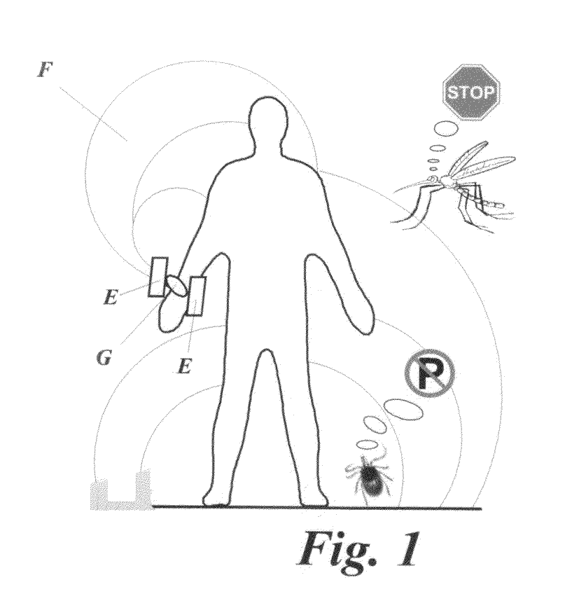

Over the skin of humans (animals) molecules evaporate that insects can detect from a distance and this directs them to their target. The innovation will cover a human or other living objects with an electric field in a kind of synthetic aura, and means to manipulate these fields will allow the generation of a cloak with a range of approximately one foot around the human body (FIG. 1). When insects enter this field, their nerve system will become confused and overwhelmed with electric impulses that prevent them from continuing their attack. The innovation describes a device that creates alternating electric fields with alternating frequencies and voltage levels. It is comfortable in use and can be used in a mobile fashion or stationary while being absolutely safe to humans and animals.

### STATE OF THE ART

Today, authorities spread chemical agents on surfaces in endangered environments such as swamps or other wet areas near urban locations. On the market there are also a variety of oils and creams and chemical sprays that promise protection, at least for a limited time. High voltage UV lamps, so called insect killers, attract flying insects and kill them with a high-voltage impulse. There are also physical barriers such as screens for windows and doors that allow air to pass through, but not insects.

### THE INNOVATION UNDERLYING PRINCIPLE

E-fields can be generated by changing the polarity of an electrode. This can be done by a tiny e-field generator. Such a device can be attached on a wrist for mobile use or on foil for beds and (wheel-) chairs. If a user carries such a device near their body, an electrical field spreads out around the surface of the skin. The signals that these e-fields provide (alternating frequency and voltage levels) prevent insect attacks if an insect comes within reach of such fields. The sensitive insect nervous system will be confused by the electrical impulses resulting in the insect leaving this uncomfortable situation. FIG. 1 shows the principle.

### Functional Principle

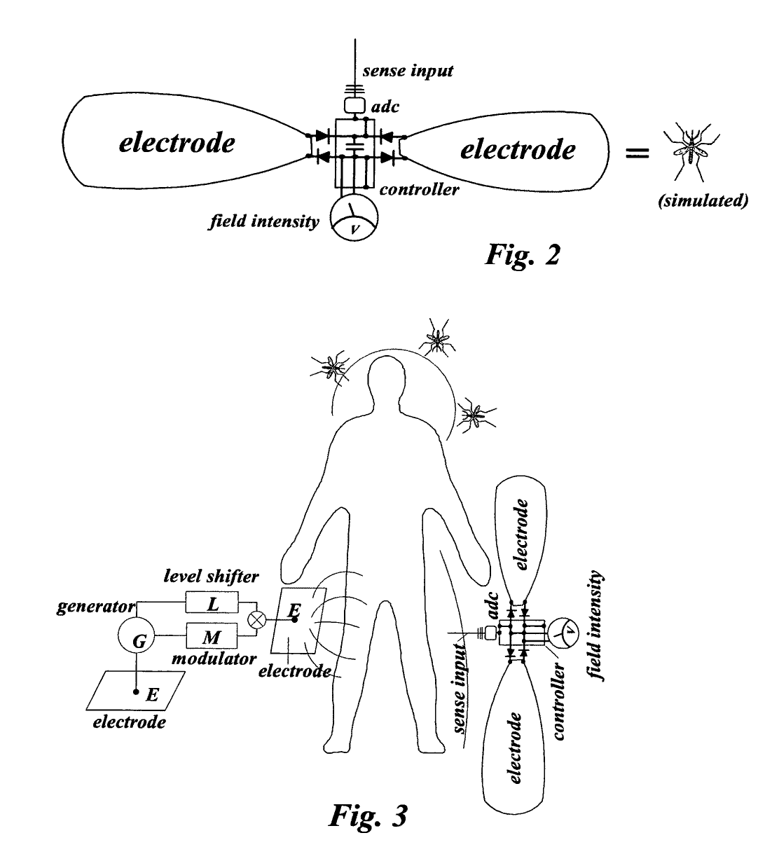

FIG. 2 shows a possible solution of the invention. An electric field (F) can be generated using a microcontroller and firmware or state machine, programmable logic device or other devices. A frequency generator (G) realized in hardware or software generates frequencies to an output pin. A level shifter generates an adjustable voltage out of this frequency. A modulator can give stimulated impulses of this frequency in the determined voltage level to an electrode (E). Such an electrode can consist of any conductive material that for the sake of comfort should be flexible.

### A First Circuit Underlying the Innovation

FIG. 3 shows a generator (G) that generates an e-field (F) over the level shifter (L) and the modulator (M) occurring on the electrode (E). The energy to run the circuit comes either from the battery, accumulator, gold cap or energy harvester, solar cell or other power source.

### A First Application

A user wears a wristband with a device that contains the invention underlying circuit. Although it is recommended to run this circuit continuously, there is also a switch to turn the device on and off, as well as means to charge the batteries inside. The electrodes are in the wristband so there is no need for direct skin contact. The wristband can be carried on an arm or on a leg, and it also works in water or rain.

### The Invention Underlying Further Applications

As nearly any microcontroller or programmable device can create such an electric field, it is possible to integrate the invention in carry-on devices like mobile phones, camera, mp3 players, remote controllers, shoes, hats and clothes. The protection is given as long as the device is near the body. Various kinds of necklaces, belts, or eye wear can also carry the invention device.

### The Invention Underlying “Test Mosquito”

To be sure that the generated alternating electric field covers the full body, the innovation provides a means to prove and test the electric field. FIG. 2 shows the principle of a “test insect” which is affected by the electric field when it comes within reach of either the diodes or field effect transistor, rectifying an alternating energy AC to DC over the insect model wings which are from a conductive material, and the energy is buffered in capacitive C and powers the microcontroller M connected to an analog measurement input where the electrode potential, the frequency modulation resonance effect and other physical and electrical phenomenon can be measured with software in the microcontroller. The data can be visualized, transmitted or stored for further examination. Electro-potential measurement on real insects can be used as a knowledge base to align the right frequency and voltage level of the generated defense electric field. It is also possible to determine reach and intensity of the electric field in various position of the subject (human or animal) body. It is also possible to detect and analyze movements of insects (or other attackers) nearby for system preparation, alerting or defending sequences.

What is claimed is:

1. System, device, methods and means for protecting humans, animals and plants from being attacked by electro-sensitive animals (like sharks) or insects such as mosquitoes, ticks or other possible disease-carrying organisms.

2. According to claim 1 is the use of an alternating electric field as a kind of defensive synthetic aura against attack around a user's body or an object.

3. According to claims 1 and 2, as a device that can be carried on or near a user in a mobile version.

4. According to claims 1 and 2, as a device integrated into furniture, or any kind of seat or bed.

5. According to claims 1 and 2, as a device with electrodes in a kind of grid for smart carpets, smart floor or other fabric used by human users or animals, and in wearable clothes, saddles or blankets.

6. According to claims 1 and 2, as an add-on for mobile devices like mobile phones, mp3 players, cameras, camcorder, radios, remote controls or other mobile devices.

7. According to claims 1 and 2, as in the form of a wristband to wear on limbs or legs.

8. According to claims 1 and 2, as a device that has at least one electrode attached to any kind of belt.

9. A device for simulating electro-sensitive insect or animals for testing the aura and the level of electric influence as a base of scientific research and proof-of-concept.

10. A device according to claims 1 and 2 attached to toys to protect children or animals or others while playing.

11. Device(s) and methods according to claims 1 and 2 for protecting against attacks from other electro-sensitive organisms from virus, bacterium, insects or animals.

12. Means according to claims 1 and 2 for protecting plants or food plants from insect or bacterium attacks.

13. Means according to claims 1 and 2 for protecting four-legged animals like cats, dogs, horses, cattle, or others.

14. According to claims 1, 2 and 13 for protecting birds from insects, parasites, viruses or bacterium attacks.

15. Device according to claims 1 and 2 as a waterproof version for outdoor use in wet areas like swamps, lakes, rivers, swimming pools or other venues.

16. Innovation according to claims 1 and 2 for modulating an alternating electric field with identifying data to identify the device or the user.

17. A detector or means for creating statistical data or feedback from the use of the device according to claim 1 or 2.

18. According to claims 1 and 2, an electronic device that is able to create at least one alternating electric field varying in frequency or voltage level. Sequences or pattern can be created for multiple uses.

19. A device according to claims 1 and 2, printed on a polymer foil as a printed electronic with an e-field generator and/or electrodes as a single or multi-layer on flexible material like a polymer or other.

20. An electronic device according to claims 1 and 2 integrated in a silicon chip as stand-alone solution or add-on for other electronic printed boards (PCB or hybrid circuit).

21. According to claims 1 and 2, for electrochemical alteration of agents or chemicals against insects (or animal) attacks, where the alternating e-field alters the molecular condition to improve it's effectively.

22. Underlying claims 1 and 2, capability to detect, analyze or identify intruding objects.

23. Downloadable software or Apps into a related device which allows communicating with or controlling the invention.
